(19) United States
(12) Patent Application Publication
(10) Pub. No.: US 2004/0008289 A1
(43) Pub. Date: Jan. 15, 2004

(54) Apparatus and method for correcting CRT focusing

(75) Inventors: Gyu-Hwa Hwang, Hwaseong-si (KR); Suk-Sun Lee, Anyang-si (KR); Jong-Sul Min, Hwaseong-si (KR); Il-Hyeon Ryu, Suwon-si (KR); Nam-Gyu Lim, Suwon-si (KR)

Correspondence Address: SUGHRUE, MION, ZINN, MACPEAK & SEAS, PLLC, 2100 Pennsylvania Avenue, N.W., Washington, DC, 20037-3202, US

(73) Assignee: SAMSUNG ELECTRONICS CO., LTD.

(21) Appl. No.: 10/607,192

(22) Filed: Jun. 27, 2003

(30) Foreign Application Priority Data
Jul. 12, 2002 (KR) 2002-40673

(51) Int. Cl. H04N 3/22

(52) U.S. Cl. 348/745; 348/747

(57) ABSTRACT

Provided are an apparatus and method for controlling CRT focusing in a television, and more particularly, an apparatus and method for separately controlling focusing of R, G, and B cathode ray tubes in a television using a triple tube type optical system based on a digital method. The apparatus includes a memory, a controller, and an R/G/B focusing correction signal generator. The memory stores focusing correction data of R, G, and B cathode ray tubes for a position of a screen. The controller reads and outputs the focusing correction data of the R, G, and B cathode ray tubes from the memory for the position of the screen, based on horizontal and vertical synchronization signals. The R/G/B focusing correction signal generator calculates the focusing correction data of the R, G, and B cathode ray tubes read from the memory and generates R, G, and B analog focusing correction signals that will be applied to R, G, and B coils.

### BACKGROUND OF THE INVENTION

This application claims the priority of Korean Patent Application No. 2002-40673, filed on Jul. 12, 2002, in the Korean Intellectual Property Office, the disclosure of which is incorporated herein in its entirety by reference.

1. Field of the Invention

The present invention relates to an apparatus and method for controlling CRT focusing of a television, and more particularly, to an apparatus and method for correcting CRT focusing by which focusing of R/G/B CRTs is separately controlled in a television using a triple tube type projection optical system based on a digital method.

2. Description of the Related Art

A projection television or a beam projector television using a triple tube type projection system includes cathode ray tubes (CRTs) which display red, green, and blue color images, respectively, and then projects the red, green, and blue color images onto a screen. However, as shown in FIG. 1, the projection distances and the projection angles from R, G, and B CRTs 110A, 110B, and 110C through a mirror 120 to a screen 100 are different depending on the position of the screen 100, a phase distortion appears on the screen 100. A CRT focusing correcting apparatus has been developed to solve this phase distortion problem.

As shown in FIG. 3, a CRT focusing correcting apparatus according to the prior art includes first and second integral circuits 310 and 320, an adder 330, and an amplifier 340.

The first and second integral circuits 310 and 320 integrate a horizontal synchronization signal H_Sync and a vertical synchronization signal V_Sync, respectively. The mixer 330 mixes signals output from the first and second integral circuits 310 and 320, and then generates a parabola waveform. The amplifier 340 amplifies a focusing correction signal of the Parabola waveform and then applies the focusing correction signal to R, G, and B CRT focusing coils so that CRT focusing is corrected.

However, as shown in FIG. 1, the projection distances and the projection angles from the R, G, and B CRTs 110A, 110B, and 110C to the screen 100 are different depending on the positions of the R, G, and B CRTs 110A, 110B, and 110C from the screen 100. Thus, images output from the R, G, and B CRTs 110A, 110B, and 110C are distorted as shown in FIGS. 2 (A)-(C).

Therefore, according to the CRT focusing correcting apparatus according to the prior art, although the projection distances and the projection angles from the R, G, and B CRTs 110A, 110B, and 110C to the screen 100 are different depending on the positions of the R, G, and B CRTs 110A, 110B, and 110C from the screen 100, focusing of the R, G, and B CRTs 110A, 110B, and 110C is corrected by using a focusing correction signal of a single parabola waveform. Thus, CRT focusing cannot be precisely controlled. Also, in an analog method according to the prior art, the parabola waveform used for focusing control varies as a time constant value of an integral circuit. Due to this, focusing cannot be precisely corrected at every position of a screen.

In general, CRT focusing correction is performed by employing the above-mentioned correction by a circuit and correction by an optical system using an optical system. In a case where the magnitude of correction operation by the circuit is small or inaccurate, the optical system has to precisely correct focusing. Thus, an optical system of a projection television according to the prior art requires a larger number of lenses to compensate for the insufficient correction of CRT focusing by the circuit. Also, since each of the lenses has to have a precise curvature, the optical system is complicated and costs for components thereof increases.

### SUMMARY OF THE INVENTION

Accordingly, the present invention provides an apparatus and method for correcting CRT focusing by which a triple tube type optical system can be simplified by separately controlling focusing of R, G, and B CRTs in a television using the triple tube type optical system based on a digital method.

According to an aspect of the present invention, there is provided an apparatus for correcting CRT focusing in an image processing system having a triple tube type optical system. The apparatus includes a memory, a controller, and a R/G/B focusing correction signal generator. The memory stores focusing correction data of R, G, and B cathode ray tubes for position of a screen. The controller reads and outputs the focusing correction data of the R, G, and B cathode ray tubes from the memory for position of the screen based on horizontal and vertical synchronization signals. The R/G/B focusing correction signal generator calculates the focusing correction data of the R, G, and B cathode ray tubes read from the memory and generates R, G, and B analog focusing correction signals that will be applied to R, G, and B coils.

According to another aspect of the present invention, there is provided a method of correcting CRT focusing in an image processing system having a triple tube type optical system. Focusing correction data of R, G, and B cathode ray tubes are determined for position of a screen and the focusing correction data is stored in a memory. The focusing correction data of the R, G, and B cathode ray tubes is read from the memory for position of the screen based on horizontal and vertical synchronization signals. A parabola focusing correction signal that will be applied to focusing coils of the R, G, and B cathode ray tubes is generated by applying the read focusing correction data of the R, G, and B cathode ray tubes to a predetermined calculation equation.

### BRIEF DESCRIPTION OF THE DRAWINGS

The above features and advantages of the present invention will become more apparent by describing in detail exemplary embodiments thereof with reference to the attached drawings in which:

FIG. 1 is a view illustrating CRTs and a screen of a general projection television;

FIG. 2 is a view illustrating the states of pictures projected onto a screen by R, G, and B CRTs shown in FIG. 1;

FIG. 3 is a view of a CRT focusing correcting apparatus according to the prior art;

FIG. 4 is a block diagram of a projection television using a CRT focusing correcting apparatus according to the present invention;

FIG. 5 is a detailed circuit diagram of an R/G/B focusing correcting signal generator shown in FIG. 4;

FIG. 6A is a view of an optical system according to the present invention; and

FIG. 6B is a view of an optical system according to the prior art.

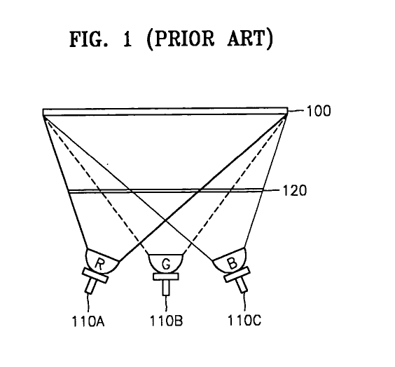

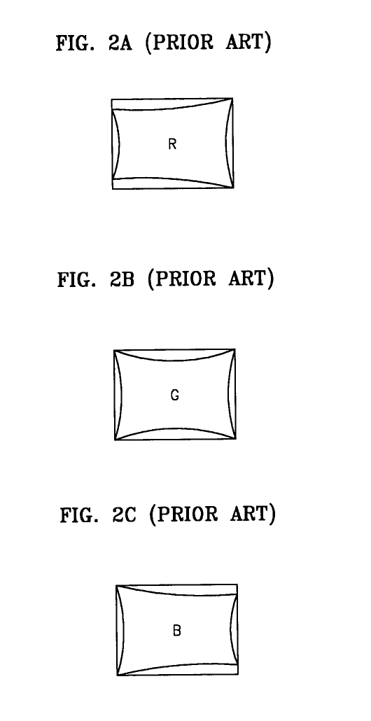

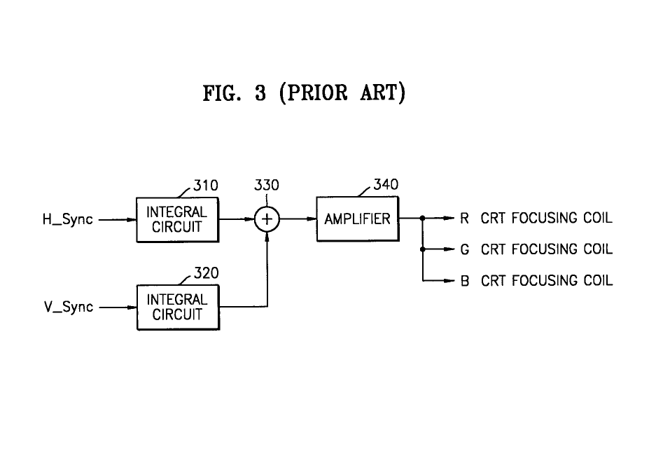

### DETAILED DESCRIPTION OF THE INVENTION

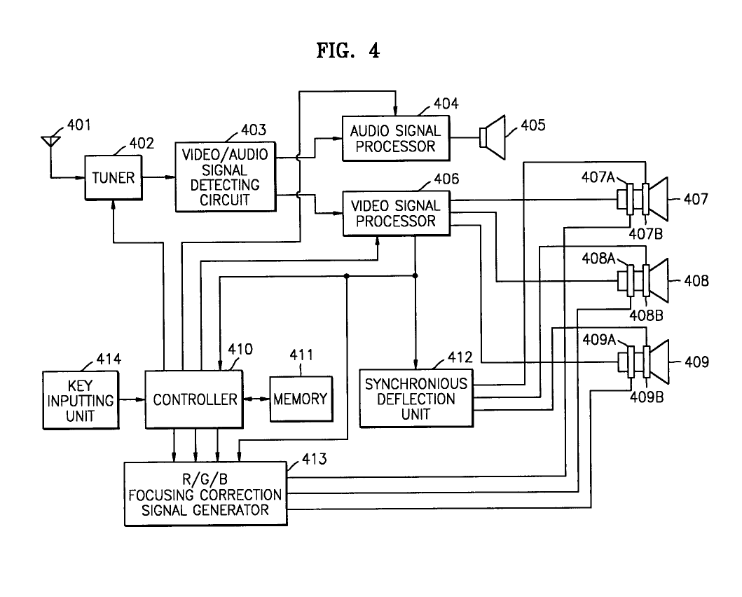

As shown in FIG. 4, a projection television using a CRT focusing correcting apparatus according to the present invention includes an antenna 401, a tuner 402, a video/audio signal detecting circuit 403, an audio signal processor 404. a speaker 405, a video signal processor 406, R, G, B CRTs 407, 408, and 409, a controller 410, a memory 411, a synchronous deflection unit 412, an R/G/B focusing correction signal generator 413, and a key inputting unit 414.

The R, G, B CRTs 407, 408, and 409 have focusing coils 407A, 408A, and 409A and deflection coils 407B, 408B, and 409B, respectively.

The basic operation of the projection television will now be described.

If the projection television is turned on using a key button of the key inputting unit 414, and then a channel to be viewed is selected, the controller 410 generates a channel control signal used for tuning the selected channel. The tuner 402 selects only a broadcasting signal of a channel selected by a user from the broadcasting signals received via the antenna 401 and outputs the selected broadcasting signal, using the channel control signal. Then, the video/audio signal detecting circuit 403 detects an audio signal and a video signal from the broadcasting signal input from the tuner 402 and outputs the audio signal and the video signal to the audio signal processor 404 and the video signal processor 406, respectively. The audio signal processor 404 removes noise from the audio signal and compensates for frequency characteristics of the audio signal and then outputs the audio signal to the speaker 405. The video signal processor 406 removes noise from the video signal and compensates for a gamma value of the video signal, converts the video signal to an R/G/B signal, and outputs the R/G/B signal to the R, G, and B CRTs 407, 408, and 409. Electronic beams output from the R, G, and B CRTs 407, 408, and 409 are deflected by a deflection voltage generated by the synchronous deflection unit 412 and then projected onto a screen (not shown). Here, a focusing correction signal generated by the R/G/B focusing correction signal generator 413 is applied to R, G, and B focusing coils 407A, 408A, and 409A to correct focusing of the R, G, and B CRTs 407, 408, and 409.

The operation for correcting CRT focusing according to the present invention will be described in detail.

First, the memory 411 stores focusing correction data of the R, G, and B CRTs 407, 408, and 409 for each position of the screen. The focusing correction data includes focusing correction data synchronized with a horizontal synchronization signal and focusing correction data synchronized with a vertical synchronization signal.

The memory 411 may store focusing correction data corresponding to all pixel positions of the screen. However, the memory 411 stores only focusing correction data in a specific seed point and calculates focusing correction data in all points of the screen using the focusing data in the seed point, so that capacity of the memory 411 can be efficiently reduced. In an embodiment of the present invention, a technique for correcting CRT focusing using correction data in a seed point is used.

The controller 410 receives a horizontal synchronization signal H_Sync and a vertical synchronization signal V_Sync output from the video signal processor 406, reads from the memory 411 focusing correction data of each of the R, G, and B CRTs 407, 408, and 409 that is synchronized with the horizontal signal H_Sync at every position of the screen and focusing correction data of the R, G, and B CRTs 407, 408, and 409 that is synchronized with the vertical signal V_Sync at every position of the screen, and outputs the read focusing correction data to the R/G/B correction signal generator 413.

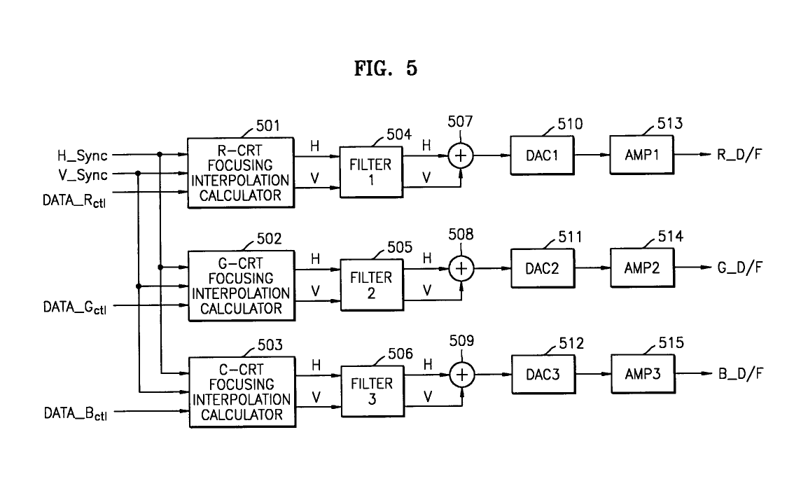

The operation of the R/G/B focusing correction signal generator 413 will be described with reference to FIG. 5. Referring to FIG. 5, the R/G/B focusing correction signal generator 413 includes R-, G-, and B-CRT focusing interpolation calculators 501, 502 and 503, first, second, and third filters 504, 505, and 506, adders 507, 508, and 509, first, second, and third digital-to-analog converters (DACs) 510, 511, and 512, and first, second, and third amplifiers 513, 514, and 515.

A horizontal synchronization signal H_Sync and a vertical synchronization signal V_Sync are applied to the R-, G-, and B-CRT focusing interpolation calculators 501, 502, and 503. Focusing correction seed data Data_Rctl, Data_Gctl, and Data_Bctl, which is read from the memory 411 by the controller 410 and synchronized with the horizontal synchronization signal H_Sync and the vertical synchronization signal V_Sync, is input to the R-, G-, and B-CRT interpolation calculators 501, 502, and 503.

The R-, G-, and B-CRT focusing interpolation calculators 501, 502, and 503 calculate the input focusing correction seed data Data_Rctl, Data_Gctl, and Data_Bctl according to a predetermined interpolation calculation equation and obtain horizontavvertical focusing correction data in all positions of the screen. The predetermined interpolation calculation equation may be an average interpolation calculation equation.

In an event that the memory 411 stores focusing correction data in all pixels of the screen, the R-, G-, and B-CRT focusing interpolation calculators 501, 502, and 503 are removed, and then the horizontal/vertical focusing correction data synchronized with the horizontal synchronization signal H_Sync and the vertical synchronization signal V_Sync is directly input to the first, second, and third filters 504, 505, and 506.

Then, the first, second, and third filters 504, 505, and 506 filter noise from the focusing correction data synchronized with the horizontal synchronization signal H_Sync and the vertical synchronization signal V_Sync, respectively.

The mixers 507, 508, and 509 mix the horizontal focusing correction data and the vertical focusing data output from the first, second, and third filters 504, 505, and 506, respectively.

The first, second, and third DACs 510, 511, and 512 convert the mixed focusing correction data of the mixers 507, 508, and 509 to an analog signal. The first, second, and third amplifiers 513, 514, and 515 amplify the analog signal and then generate R, G, and B dynamic focusing correction signals R_D/F, G_D/F, and B_D/F that will be applied to the R, G, and B focusing coils 407A, 408A, and 409A.

In the above-described circuit diagram, focusing of R, G, and B CRTs can be separately corrected in a television using a triple tube type projection system based on a digital method.

A method of correcting CRT focusing according to the present invention will be described.

First, a first process of determining focusing correction data of R, G, and B CRTs in each position of a screen and storing the focusing correction data in a memory is performed.

By accessing a memory designed according to the first process, a second process of reading focusing correction data of the R, G, and B CRTs in each position of the screen based on horizontal and vertical synchronization signals is performed.

A third process of interpolation-calculating the focusing correction data of the R, G, and B CRTs and mixing the focusing correction data synchronized with the horizontal synchronization signal and the focusing correction data synchronized with the vertical synchronization signal is performed.

A fourth process of converting the mixed focusing correction data to an analog signal and generating a parabola focusing correction signal that will be applied to focusing coils of the R, G, and B CRTs is carried out.

Focusing of R, G, and B CRTs can be separately controlled using the first, second, third, and fourth processes according to a digital method. If a memory is designed to store focusing correction data in all pixels of a screen, the interpolation calculation in the third process is omitted.

By separately controlling focusing of R, G, and B CRTs according to a digital method, the configuration of lenses of an optical system can be remarkably simplified.

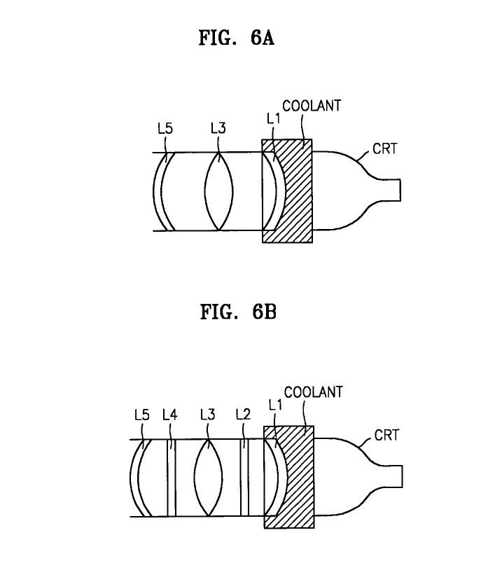

In other words, as shown in FIG. 6 (B), a conventional optical system of a projection television, which uses a focusing controlling apparatus for integrally controlling focusing of R, G, and B CRTs according to a digital method, requires at least five lenses for correcting chromatic aberration including a power lens L3. Each of the lenses has to be manufactured at a high precision.

In contrast, by precisely correcting CRT focusing using the apparatus according to the present invention, the curvature shape of a lens can be simplified by alleviating the correction degree of focusing in an optical system. Also, efficiency for correcting focusing can be improved by using only three lenses including the power lens L3 to compensate for chromatic aberration, compared with the prior art. Thus, in the optical system of a projection television according to the present invention, the number of lenses can be reduced compared to the prior art.

As described above, by separately correcting focusing of R, G, and B CRTs according to the digital method according to the present invention, focusing can be precisely corrected at every position of a screen. Also, the number of lenses constituting an optical system can be reduced compared with the prior art and the curvature shape of the lenses can be simplified, thereby allowing easy manufacturing of the lenses.

The present invention can be realized as a method, an apparatus, a system, and so forth. When the present invention is executed as software, the components of the present invention are code segments, which carry out necessary operations. Programs or code segments may be stored in a processor-readable medium or may be transmitted from a transmission medium or a communication network by a computer data signal combined with a carrier wave. The processor-readable medium includes any media, which can store or transmit information. The process-readable medium includes an electronic circuit, a semiconductor memory device, a ROM, a flash memory, a E²PROM, a floppy disc, an optical disc, a hard disc, an optical fiber medium, a radio frequency (RF) network, and the like. The computer data signal includes any signals, which can be transmitted over the transmission medium, such as an electronic network channel, an optical fiber, air, an electronic system, the RF network, or the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for correcting CRT focusing in an image processing system having a triple tube type optical system, the apparatus comprising:
a memory that stores focusing correction data of R, G, and B cathode ray tubes for a position of a screen;
a controller that reads and outputs the focusing correction data of the R, G, and B cathode ray tubes from the memory for the position of the screen based on horizontal and vertical synchronization signals; and
an R/G/B focusing correction signal generator that calculates the focusing correction data of the R, G, and B cathode ray tubes read from the memory and generates R, G, and B analog focusing correction signals that will be applied to R, G, and B coils.

2. The apparatus of claim 1, wherein the focusing correction data stored in the memory is focusing correction seed data that is determined in a predetermined number of seed points on the screen.

3. The apparatus of claim 1, wherein the focusing correction data comprises focusing correction data that is synchronized with the horizontal synchronization signal and focusing correction data that is synchronized with the vertical synchronization signal.

4. The apparatus of claim 1, wherein the R/G/B focusing correction signal generator comprises:
an R/G/B focusing calculator that calculates the focusing correction seed data of the R, G, and B cathode ray tubes read from the memory according to a predetermined interpolation calculation equation, mixes the focusing correction data synchronized with the horizontal synchronization signal and the focusing correction data synchronized with the vertical synchronization signal at every position of the screen, and obtains the focusing correction data of the R, G, and B cathode ray tubes;
a digital-to-analog converter that converts the focusing correction data of the R, G, and B cathode ray tubes output from the R/G/B focusing calculator to an analog signal; and
an amplifier that amplifies the converted analog focusing correction signal to a voltage that will be applied to R, G, and B focusing coils.

5. The apparatus of claim 4, wherein the R/G/B focusing calculator comprises:
R-, G-, and B-cathode ray tube interpolation calculators that interpolation-calculate the horizontally synchronized focusing correction seed data and the vertically synchronized focusing correction seed data of the R, G, and B cathode ray tubes read from the memory;
R, G, and B filters that filter noise from the interpolation-calculated focusing correction seed data; and
R, G, and B mixers that mix and output the horizontally synchronized focusing correction data and the vertically synchronized focusing correction data of the R, G, and B cathode ray tubes output from the R, G, and B filters, respectively.

6. The apparatus of claim 1, wherein the R/G/B focusing correction signal generator comprises:
an R/G/B focusing calculator that calculates the horizontally synchronized focusing correction data and the vertically synchronized focusing correction data of the R, G, and B cathode ray tubes read from the memory and obtains focusing correction data of the R, G, and B cathode ray tubes;
a digital-to-analog converter that converts the focusing correction data of the R, G, and B cathode ray tubes output from the R/G/B focusing calculator to an analog signal; and
an amplifier that amplifies the converted analog focusing correction signal to a voltage that will be applied to R, G, and B focusing coils.

7. The apparatus of claim 6, wherein the R/G/B focusing calculator comprises:
R, G, and B filters that filter noise from the focusing correction data synchronized with the horizontal synchronization signal and the focusing correction data synchronized with the vertical synchronization signal that is read from the memory; and
R, G, and B mixers that mix and output the horizontally synchronized focusing correction data and the vertically synchronized focusing correction data of the R, G, and B cathode ray tubes output from the R, G, and B filters, respectively.

8. A method of correcting CRT focusing in an image processing system having a triple tube type optical system, the method comprising:
(a) determining focusing correction data of R, G, and B cathode ray tubes for a position of a screen and storing the focusing correction data in a memory;
(b) reading the focusing correction data of the R, G, and B cathode ray tubes from the memory for the position of the screen based on horizontal and vertical synchronization signals; and
(c) generating a parabola focusing correction signal that will be applied to focusing coils of the R, G, and B cathode ray tubes by applying the read focusing correction data of the R, G, and B cathode ray tubes to a predetermined calculation equation.

9. The method of claim 8, wherein the focusing correction data stored in the memory is focusing correction seed data that is determined in a predetermined number of seed points on the screen.

10. The method of claim 8, wherein the focusing correction data comprises focusing correction data that is synchronized with the horizontal synchronization signal and focusing correction data that is synchronized with the vertical synchronization signal.

11. The method of claim 8, wherein in step (c), the focusing correction data of the R, G, and B cathode ray tubes synchronized with the horizontal synchronization signal and the focusing correction data of the R, G, and B cathode ray tubes synchronized with the vertical synchronization signal are mixed, and then a parabola focusing correction signal that will be applied to the focusing coils of the R, G, and B cathode ray tubes is generated based on the mixed focusing correction data.

12. The method of claim 8, wherein in step (c), the focusing correction seed data of the R, G, and B cathode ray tubes synchronized with the horizontal synchronization signal and the focusing correction seed data of the R, G, and B cathode ray tubes synchronized with the vertical synchronization signal are interpolation-calculated, the interpolation-calculated focusing correction data synchronized with the horizontal synchronization signal and the interpolation-calculated focusing correction data synchronized with the vertical synchronization signal are mixed, and the parabola focusing correction signal that will be applied to the focusing coils of the R, G, and B cathode ray tubes is based on the mixed focusing correction data.
